(19) United States
(12) Patent Application Publication
(10) Pub. No.: US 2006/0225337 A1
(43) Pub. Date: Oct. 12, 2006

(54) Leader and leader sections for use in fly fishing

(76) Inventor: Patrick E. Moffitt, Califon, NJ (US)

Correspondence Address: Glen M. Diehl;NORTON & DIEHL LLC, Suite 110, 77 Brant Avenue, Clark, NJ, 07066, US

(21) Appl. No.: 11/102,276

(22) Filed: Apr. 8, 2005

(51) Int. Cl. A01K 91/16; A01K 91/00; A01K 91/14

(52) U.S. Cl. 43/44.98

(57) ABSTRACT

A leader for use in fly fishing is disclosed. The leader is connected between a fly line and a tippet section. In one embodiment, the leader includes a first section of wire connected to the fly line and a second section of polymeric monofilament. The section of wire can be a shape memory alloy or a superelastic alloy. Nitinol is a preferred alloy for use in the wire section of the leader. The section of wire is attached to the second section of polymeric monofilament. One of more sections of wire can be used in the leader. Each of the sections of wire can be tapered. Additionally, one or more sections of polymeric monofilament can be used in the leader. In another embodiment of the present invention, a single section or multiple sections of wire, preferably shape memory alloy wire or superelastic alloy wire, can be used. The wire leader is able to store mechanical energy generated by the cast allowing the leader to function as intended with greater frequency.

### BACKGROUND OF THE INVENTION

The present invention relates to fly fishing and more specifically to the leader attached between the fly line and hook.

Three different classes of lines connected between the reel and the fly are used in fly fishing. Each of these line types, backing, fly line and leader, serve a separate and unique purpose. These lines, as such, are constructed, packaged and sold as distinct elements.

The backing, attached to the reel and the distal end of the fly line, serves to provide sufficient line to subdue a large fish. The backing's lack of taper, high breaking strength, and small diameter allows additional line to be added to the reel spool than would otherwise be possible with the large diameter fly line. The amount of backing attached to the reel can be of any length suitable to the reel and fishing situation. Lengths are normally fifty to three hundred yards. Line used as backing is generally a braided Dacron® or gel spun polyethylene and is intended for years of service.

The fly line is the principle device used to attain distance casting a fly and is connected to the backing by various knots or loops. Fly lines are created with complex tapers and of various weights to match the rod being used and the type of fishing conducted. A fly line is manufactured by extruding a plastic coating of variable thickness over a non-tapered core generally composed of braided Dacron®. The material used to construct the coating may be formulated to enhance certain line characteristics such as line weight, flotation or sinking rate. An average length for a fly line is ninety feet. A fly line is intended for several years of service prior to replacement.

Shorter sections of fly line, called sink tips, are also manufactured and sold. A sink tip is meant for loop connection to the forward end of the main fly line and to the butt of the leader. A sink tip, considered an extension of the fly line, allows the conversion of a floating fly line into a sinking fly line. Sink tips are constructed similarly to fly lines previously discussed and also are meant for years of service.

The third line class necessary to fly fishing is the leader, which is connected between the fly line and the fly or hook. Leader connection to the fly line is achieved by a variety of knots or attached loops. The leader's primary function is the proper presentation of the fly. The leader's reduced diameter with respect to the fly line increases the odds that a fly when landing near a fish will not cause it to startle. The leader's transparent aspects, allowed by the chemistries of the nylon and fluorocarbon, also increases the odds of the fly being accepted.

Current leader construction commonly consists of a butt section connected to the fly line, a tapered midsection, and a tippet section that is connected to the hook or fly. The various leader sections have traditionally been made from synthetic polymers such as nylon and fluorocarbon. The leader's butt section has a diameter or stiffness approaching that of the fly line to which it is attached. The midsection is of varying lengths and generally exhibits a hook-ward taper, so that the diameter gets smaller as the midsection nears the hook. Tapering can be achieved as part of an extrusion process or by knotting different diameters of monofilament together. A manufactured leader may also have a continuous taper from fly to the tippet.

A taper is normally incorporated into a polymeric leader to aid in uncoiling the line following a cast.

The leader's tippet section, ultimately knotted to the hook or fly, generally represents the smallest diameter material used in the leader construction. An optional shock tippet, when warranted, can be connected between the polymeric tippet and the hook. This optional section is desired when angling for very large fish capable of abrading or chewing through a polymeric tippet. A shock tippet is composed of a short section of very heavy nylon monofilament or wire, and is most often less than 12 inches in length. The shock tippet protects the finer diameter polymeric tippet, called a class tippet when a shock tippet is used, from direct contact with the aforementioned teeth or other abrasive structures.

The leader is the more disposable of the three line classes described and may only last a single fishing outing. This is a function of the materials (polymeric) used in construction and the relative position of the leader with respect to the fly and fly line. The leader is, therefore, subject to a number of elements that reduce its serviceability during the course of an angling day. These include losses of leader sections to snags or leader compromise due to wind knots and abrasion. An angler may also desire a leader change to take advantage of another leader's design characteristics that more adequately address the present angling situation.

The leader acquires most of its design characteristics such as overall length, taper, breaking strength, suppleness and the need for a shock tippet, from the type or class of flies being used and the fish species being sought. As such, many different leader designs may be appropriate for a single fly line depending in part whether the angler is dry fly, streamer or nymph fishing and the type and size of fish being sought. Leaders may be as short as five feet or 12 feet or longer in length.

Current fly leaders have significant limitations as a result of the inherent polymer characteristics used to make them. A preferred expectation, when fly fishing, is to have the leader fully uncoil and fall onto the water in a controlled manner extending in a linear fashion from fly line to fly. This expectation is not always realized using current fly fishing leaders.

A leader failing to fully uncoil is the result of the inadequate transmission of energy, imparted by the angler's cast, progressively down the fly line and leader. A properly executed cast should uncoil the fly and leader lines in much the same manner as a bull whip. A number of variables may be involved with a line failing to uncoil including, the angler's level of expertise, wind, fly size and/or added weight to the tippet.

A poor or inefficient cast results in a series of coils or S-shaped curves in the leader upon landing on the water. The fly, as a result, may land in a position nearer the angler than more forward sections of the leader. A fish stopping the fly connected to a coiled leader requires the current to move the fly line a distance comparable to the length of the coils before the detection of a strike is possible by the angler. Improper leader control, since fish are capable of taking then expelling a fly in fractions of a second's time, severely limits the angler's chance of success.

An additional limitation with current leaders made entirely of polymeric materials occurs when fishing with sinking lines. A long polymeric monofilament leader connected to a fast sinking fly line or sink tip does not allow the fly to sink to the desired depth or impedes the fly's rate of descent. Nylon has near neutral buoyancy in water while the denser sink tip or sinking fly line descends at rates as high as 8 inches per second. This causes the fly line to sink at a much higher rate than the fly. Very short leaders are normally used to offset this limitation. The fly's proximity to the large diameter and opaque fly line, however, may discourage a fish from taking the fly.

Leaders made entirely of polymeric materials in the mid and butt sections create an additional problem when fishing with subsurface flies. The low specific gravity of these materials coupled with the leaders cross-sectional area subject it to drag produced by the water's current. This can have the consequence of dragging the fly through the water in an unnatural manner and limiting the possibilities for success.

Accordingly, new and improved leaders for fly fishing are needed.

### SUMMARY OF THE INVENTION

The present invention provides a leader for use in fly fishing that resolves the limitations inherent to leaders made entirely with polymeric materials.

The leader of the present invention provides improved performance by incorporating a section or sections of metal alloyed wire, into a leader's butt and/or midsection. The wire does not replace the use of a polymeric tippet section (or a shock tippet if required). A polymeric or non-metallic tippet section is still required.

A polymer tippet section, being suppler than wire due to its lower modulus of elasticity, allows for a more natural presentation of the fly to the fish.

Polymers can be produced that are relatively transparent, not achievable with metal alloys, making them preferred for tippet construction.

A tippet created of polymeric materials is also preferred due to the ease that polymeric lines can be knotted to a fly.

A non-metallic tippet section is required if the angler desires to submit a catch for record recognition.

Wire, unlike polymeric materials, is able to store more mechanical energy produced by the cast and use it to properly uncoil the leader. A leader constructed in accordance with the invention has the ability to self-straighten following a poor cast and as a result remove much of the resulting slack from the leader. It is able to accomplish this self-straightening, using line diameters applicable to fly fishing, as a result of the wire's higher rigidity and flexural strength compared to polymers such as nylon and fluorocarbon.

A leader with the self-straightening capability is achieved by incorporating a section of appropriate wire having the ability to store sufficient mechanical energy to straighten the leader once on the water. This phenomena is known in wire manufacturing as springback. Not all wires are capable of sufficient springback, especially those made with lead alloys. Materials such as nylon and fluorocarbon, of diameters consistent with fly fishing, currently used to build an entire leader butt and midsection are too supple (not sufficiently rigid) to return or spring back into a straight orientation.

A wire's suitability for this purpose when incorporated into a leader's mid and/or butt section is related to its inherent properties including, rigidity, flexural strength, elasticity, specific gravity, and diameter among others.

The invention by incorporating wire having a high specific gravity and minimal diameter allows a leader of longer length to be used when fishing with a sinking fly line. Such a leader will not impede the attached fly's rate of descent as would be the case of a leader composed entirely of polymeric material.

The wire characteristics described above, high specific gravity and high breaking strength per unit of diameter, allows a sinking fly to be fished more effectively because it is less subject to drag caused by the water.

In accordance with a preferred embodiment, the wire is made from a class of alloys with a characteristic known as shape memory and exhibiting superelastic properties. Nitinol, a nickel/titanium alloy, is a preferred superelastic wire and alloy.

The leader of the present invention used in fly fishing includes a first section or sections of wire, a second section or sections of polymeric monofilament and means for attaching the first section of wire to the second section of polymeric monofilament and to the fly line. The wire sections can be in the butt section of the leader nearest the fly line and the monofilament sections can be in the midsection of the leader. The order of the wire sections and the monofilament sections can be reversed.

In accordance with one aspect of the present invention, the means of attachment between wire and wire, fly line and leader and wire and polymeric monofilament includes loops, knots, and crimps or other methods familiar to those in fly fishing.

In accordance with another aspect of the present invention, the means of attachment between wire and wire of similar or dissimilar diameter or composition includes adhesives, soldering, crimps, shrink tubing and welding or other methods familiar to those in metallurgy and wire manufacturing.

In accordance with one aspect of the present invention, the leader of the present invention is used in fly fishing by attaching a wire leader section between a fly line and a non-metallic tippet section. (The tippet may subsequently be attached to a shock leader.)

In accordance with another aspect of the present invention, any wire leader section or sections can be tapered. The taper is generally such that the leader becomes thinner as it nears the hook end of a fishing line or as it moves away from the fly line.

In accordance with another aspect of the present invention any polymeric leader section or sections can be tapered.

In accordance with another aspect of the present invention, the points of attachment are surrounded or coated to achieve a smoother profile. The desired effect can be achieved with adhesives, plastic, shrink tubes or sleeves. Additionally, the wire attachment points may be finished by mechanical means such as grinding or blasting.

In accordance with another aspect of the present invention, each of the sections of wire can be left in their natural oxide state, or mechanically grinded, polished or pickled.

The wire may be coated with a polymer or additional metal or alloy to achieve a desired color. Coating may be achieved by a variety of processes including spray coating, vacuum or plasma deposition techniques or other techniques known to those familiar with wire manufacture.

The wire may be additionally coated with a polymer, metal or dissimilar alloy to achieve a desired characteristic in the leader design.

The wire may additionally achieve a coating when desired by drawing the wire through the inside diameter of a separate material.

In a preferred embodiment the wire sections are straight annealed wire.

In accordance with another aspect of the present invention a section or sections of the wire may be coated. The coating may or may not be capable of altering its performance when incorporated into the leader.

### DESCRIPTION OF THE DRAWINGS

FIG. 1 illustrates a first embodiment of the leader of the present invention.

FIG. 2 illustrates a second embodiment of the leader of the present invention.

FIG. 3 illustrates a third embodiment of the leader of the present invention.

FIG. 4 illustrates various other embodiments of the leader of the present invention.

FIGS. 5, 6, 7, and 8 illustrate additional aspects of the present invention.

### DESCRIPTION OF THE PREFERRED EMBODIMENT

The leader of the present invention provides a solution to certain limitations associated with current fly leaders by incorporating one or more sections of wire into a leader's butt and/or midsection. The wire added to the leader of the present invention can replace all or portions of the butt and/or midsection of traditional leaders. Tippet sections of polymeric monofilament are preferably used with the leader of the present invention.

The leader of the present invention includes one or more sections of wire in the leaders mid and butt section. The leader of the present invention can also include one or more sections of polymeric monofilament or other non-metallic material. The one or more sections of wire and the one or more sections of polymeric monofilament can be arranged in all possible orders of spatial alignment between a fly line and the leader's tippet section.

The wire used in the present invention has a Modulus of Elasticity greater than 40 Gpa, an Ultimate Tensile Strength greater than 300 MPa and a density greater than 3.0.

The wire is preferably a straight annealed shape memory alloy exhibiting superelastic properties.

The leader of the present invention can include any traditional polymeric leader section including in its entirety the butt or midsection, however, it must include a section of wire at some point between the fly line and the tippet. An optional wire or heavy monofilament shock tippet may be connected between the tippet and the fly if so desired by the angler and does not form a part of the described inventive leader.

In accordance with one aspect of the present invention, the wire, including those made of shape memory alloys demonstrating superelastic properties can replace the butt section and/or the midsection of the leader.

Leaders made in accordance with the teachings of the present invention, particularly those that include shape memory alloys demonstrating superelastic properties, have significant advantages when compared to traditional leaders made entirely of polymeric materials for the fishing methods, such as fly fishing, described above. The mechanical properties of the shape memory alloy wire or the superelastic wire allow the leader of the present invention to store more mechanical energy when flexed by a cast than is possible with leaders using only polymeric materials. The ability to store significant mechanical energy assists in achieving a relatively straight leader orientation on the water even when the efficiency of the cast or caster is lacking. This allows the angler to stay in much better contact with the fly and identify a fish's take more efficiently increasing the chances for fishing success. Wire with a thinner diameter per rated pound of breaking strength and a higher specific gravity when compared to traditional monofilaments of polymer formulation, makes it a material less subject to drag caused by water's variable currents. The reduction of leader drag allows for a more natural presentation of the fly. Wire's thin diameter and high specific gravity also allow the fly to sink faster, requiring less weight while nymph fishing, and allows longer leaders while streamer fishing. Wire used for the leader construction is not to be confused with that used for bite or shock tippets which does not play a role in leader turnover or fly presentation as discussed above.

Shape memory alloys demonstrating superelastic properties are used to form the wire of the preferred embodiment. Superelastic alloys, were chosen for use in the preferred embodiment because of their high modulus of elasticity, high tensile strength and extreme resistance to kinking (bending into a permanent set). A wire once kinked loses a considerable percentage of its ultimate breaking strength and may further prevent the leader from proper functioning. Wire not demonstrating superelastic properties, such as stainless steel and model, are more prone to kinking and therefore may not be as desirable. Lead wire(s) does not have adequate tensile strength or springback for use in the leader and is currently being phased out as a fishing material due to environmental concerns.

The leader may take any number of different designs, as long as it incorporates wire in the butt and/or midsection, and preferably is made from a superelastic alloy. The above leader when completed with a non-metallic tippet section may take any design necessary to meet the challenges imposed by the weight of the fly line, fishing situation or angler's desire.

The wire section of the leader in a preferred embodiment of the present invention is restricted to the mid and/or butt section of the fly leader. The angler's choice, generally nylon or fluorocarbon monofilament, is attached between the distal end of the leader's midsection and the fly. A polymeric monofilament tippet is used for several reasons. Polymeric monofilament, being suppler than wire, allows the fly to drift naturally. Nylon and fluorocarbon monofilament have an index of refraction closer to water and is therefore less visible to the fish. A nylon monofilament is also easier to knot to a hook than is wire.

An angler seeking record certification by the International Game Fish Association (IGFA) must adhere to their rule requiring a fly leader to incorporate a non-metallic tippet section of at least fifteen inches into its length.

The wire section(s) of the leader, including those leaders using shape memory alloys and those using superelastic alloys, may be tapered or untapered. The ability to store large amounts of mechanical energy, however, relieves the necessity of some leaders of the present invention from requiring a taper to achieve proper leader turnover and other discussed advantages related to a leader incorporating wire.

The wire section or sections used in the preferred embodiment are of uni- or monofilament. The wire additionally may be of multi-filament construction including braids, furls or coated.

A taper in the wire, in accordance with one aspect of the present invention, may be formed by any number of methods known to wire manufacturing including extruding a single-tapered filament. The taper may additionally be achieved by arranging multiple wire filaments. The taper may additionally be created by joining different diameters or wire rigidity together by means of knots, adhesives, crimps, welding or soldering. The knots may or may not be coated with additional material such as glue or plastic sleeves to achieve a smooth connection.

The wire may be attached directly to the fly line, the fly line's leader loop or to various locations in the butt and/or midsection of the leader. Attachment may be accomplished by a variety of means including knots such as the Albright or Perfection. Wire loops may also be used for a loop-to-loop connection, and may be formed by methods including knots, soldering, welding, adhesives, swaging, shrink tubing or crimping. In one method a loop is formed with the end section of wire and then is lashed in place by means of thread. The thread is ultimately coated with an adhesive or shrink tubing. In a further embodiment the loop is formed by folding an end section of wire and held in place by shrink tubing without thread. A non-metallic material attached to the wire may also form the loop. A hollow woven materials formed into a loop, such as Dacron® may be pushed onto the wire section and fixed in place by any method previously described.

The leader may be constructed such that the angler has leader sections of varying lengths and diameters of wire looped on both ends. This enables the angler to quickly create and customize the leader in the field for the fishing situation at hand.

The leader may be constructed in a manner where it will orient itself at an angle equal to but not exceeding 90 degrees to the other sections of the fly line or leader. Called a right angle leader, this orientation is thought to improve the speed at which the leader sinks.

The monofilament tippet section may be attached to the wire in any manner described above. Construction of the leader does not require the connection type to be identical on either end. As an example, the wire may be attached to the fly line by a loop while an Albright knot connects the non-metallic tippet and wire.

The wire section can be made from an alloy such as steel. In accordance with a preferred embodiment, the wire can be made from a number of commercially available shape memory alloys. The alloys include: Nickel/Titanium alloys such as Nitinol and Tinel; Copper/Zinc/Aluminum Alloys; and Copper/Aluminum/Nickel Alloys. Other alloys that are known to display shape memory properties, that may be used in the present invention are: Silver/Cadmium alloys; Gold/Cadmium alloys; Copper/Tin alloys; Copper/Zinc alloys; Indium/Titanium alloys; Nickel/Aluminum alloys; Iron/Platinum alloys; Manganese/copper alloys and Iron/Manganese/Silicon alloys. In accordance with a most preferred embodiment of the present invention, a group nickel and titanium alloy with a near equal ratio of each metal, known as Nitinol is used. Nitinol alloys may incorporate minor amounts of additional elements known to those familiar with the manufacture of these alloys. The Nitinol may also be in the form of a tube filled with a dissimilar material such as a Drawn Filled Tube.

Shape memory alloys exhibit an elastic strain, which can be 20 times that of steel and is fully reversible. Temperature changes are not necessary for the super-elastic phenomena. The formulation and manufacture are well-known to those familiar with the art of metallurgy. As mentioned above, the preferred wire is a nickel titanium composition and is generically known as Nitinol. As is well-known, various metals and compounds can be included in the superelastic wire.

The leader section or sections of the present invention that includes wire, is not intended for direct attachment to a fly, lure or hook. The inherent characteristics of superelastic wire in the above described fly fishing application are intended to affect all or some of the following: proper leader turnover, natural presentation of the fly, reduction of drag on the leader caused by water, enhanced strike detection, crafting longer leaders and improved sinking characteristics. A non-metallic tippet section, generally nylon or fluorocarbon, is attached to the leader's butt and midsection containing a segment of wire.

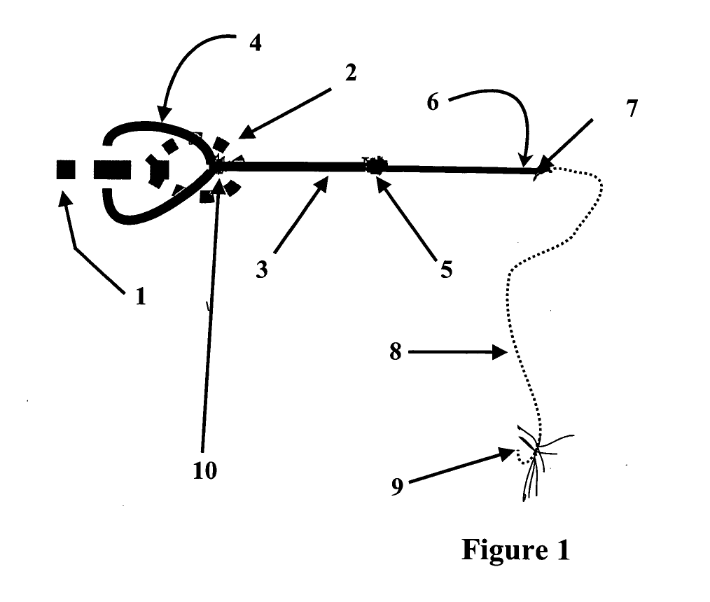

FIG. 1 shows a fly line 1 with a permanently attached loop 2. The wire loop 4 formed at connection 10 is attached to the fly line loop 2. Wire constituting the butt section 3 is attached 5 to the wire leader midsection 6. Attachment of leader sections and leader to fly line may be achieved by any means known to those skilled in fly fishing including loop-to-loop, shrink tubes, knot and glue connections. Wire sections, including loop formation, may be connected by any means familiar to those in metallurgy including soldering, welding, adhesives, crimps and swages. The wire, 3 and 6, may be tapered or untapered and further connected by a variety of known methods 7 to a polymeric monofilament tippet 8 attached to a hook or fly 9.

The embodiment of the leader illustrated in FIG. 1 includes a first section of wire 3 (the butt section) and a second section of wire 6 (the midsection). The first section of wire 3 and the second section of wire 6 is preferably made from a shape memory alloy. In a most preferred embodiment, the sections of wire 3 and 6 are made from Nitinol.

In accordance with one aspect of the present invention, the section of wire 6 has a smaller diameter than the section of wire 3. When in use fly fishing, the wire 6 constituting the mid-section of the leader is attached to a monofilament tippet 8 by means of a knot 7. The tippet is then attached to a fly or hook 9 when fishing.

The leader of FIG. 1 is preferably constructed and packaged as a single unit that includes the first wire section 3 and the second wire section 6. The first section 3 and the second section 6 are preferably, but not necessarily, attached in the package. A tippet may or may not be attached when packaged.

Any of the previously mentioned attachment joints can be used. As previously mentioned, the diameter of the section 6 can be smaller than the diameter of the section 3 to create a taper. Further the attachment joint(s) can be covered by glue, plastic or sleeves or other applicable coatings. Further, each of the sections of wire 3 and 6 can be coated with any coating that is commonly used to coat wires, shape memory alloys and superelastic alloys.

In accordance with another aspect of the present invention, additional sections of wire can be added to sections 3 and 6 to increase its overall length or alter its taper. For example, another section of wire that has a smaller diameter than the diameter of wire 6 can be added to the section 6 near the joint 7 or equivalent diameter sections may be added to increase overall length.

In accordance with another aspect of the present invention, the sections of wire 3 and 6 can incorporate a taper produced during wire manufacture.

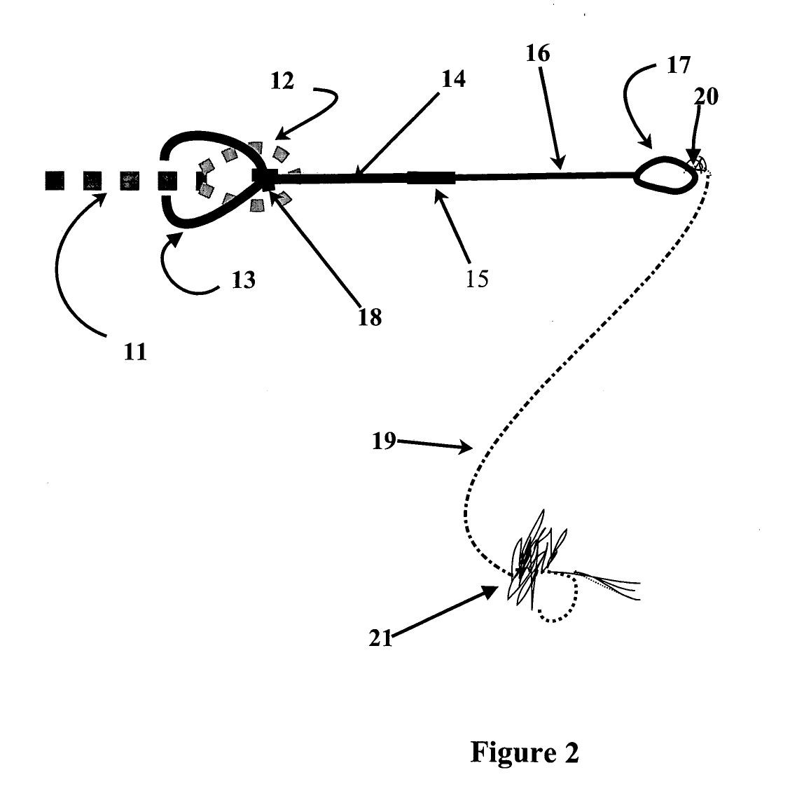

FIG. 2 shows a fly line 11 and loop connector 12 attached to the loop 13, formed at 18, of monofilament line used as a leader butt section 14. The monofilament loop may be formed by any method commonly known. The polymeric monofilament section 14 is knotted at joint 15 to a length of wire 16, which terminates in a loop 17. Anon-metallic monofilament tippet 19 is knotted 20 to the wire loop 17 on one end and to a fly or hook 21 on the other. The monofilament used in the butt and tippet sections is preferably nylon or fluorocarbon in formulation. The butt section can be nylon while the tippet can be fluorocarbon material. The wire 16 is preferably a shape memory alloy exhibiting superelastic properties. In a most preferred embodiment, the wire 16 is Nitinol.

The leader of FIG. 2 is preferably manufactured and packaged as a single unit that includes the polymeric monofilament section 14 and the attached wire 16. The wire 16 is preferably a superelastic alloy wire, and most preferably is Nitinol. The polymeric monofilament section 14 and the wire 16 can be knotted together or joined together by any means known to those skilled in the art, or they can be separate and attached by the user.

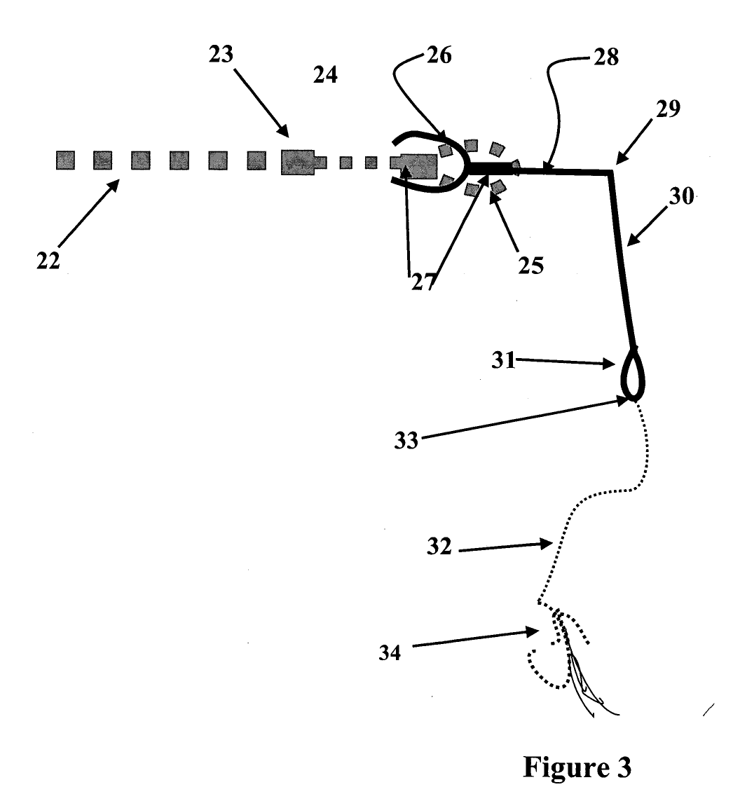

FIG. 3 shows a fly line 22 with a section of polymeric monofilament section 24 nail knotted 23 to the fly line and terminating in a loop 25 which is looped to a wire leader loop 26. A wire section 28 is formed into an angle preferably not exceeding 90 degrees at point 22 and wire section 30. Wire section 30 then runs at a 90 degree angle to wire section 28. The angle shown in 29 can be achieved by knotting together two sections of wire in such a way that the shown orientation is produced. Additionally, bending preferably during heat treatment such that a continuous section of wire is used can form the angle 29. The wire leader midsection 30 terminates in a loop 31. A tippet 32 is attached by knot 33 to the wire loop 31 and to a fly 34. Once again, the incorporated wire, 28 and 30, is preferably a shape memory alloy demonstrating superelastic properties, and most preferably is Nitinol. A severe angle shown in 29 may also be formed, preferably not exceeding 90 degrees, in the polymeric monofilament section 24.

The leader of FIG. 3 is preferably constructed and packaged as a single unit that includes the wire sections 28 and 30 with the described offset 29 and attachment loops 26 and 31. A tippet 32 may or may not be included.

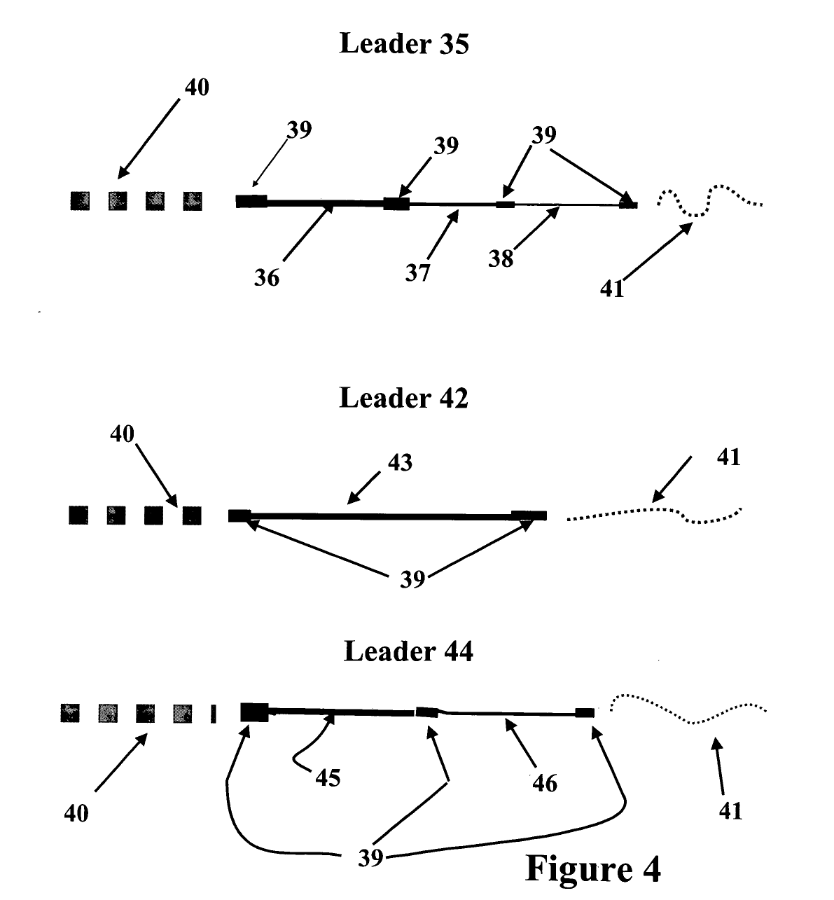

FIG. 4 illustrates various other aspects of the present invention. Each of the leaders shown in FIG. 4 includes a wire section. The wire sections in each leader are preferably shape memory alloy wire or superelastic wire alloy, and in a most preferred embodiment, are Nitinol.

Leader 35 can include a first section of wire 36, a second section of wire 37 and a polymeric monofilament section 38. Sections 36, 37 and 38 can be attached via any of the attachment means 39 previously described. Leader section 36 is meant to be connected to a fly line 40 and leader section 38 is meant to be connected to a non-metallic tippet 41. Additional sections of wire and additional sections of polymeric monofilament can be added. Further the sections 36, 37 and 38 can be of varying diameters to achieve a taper.

Leader 42 has a single section of wire 43 comprising both the butt and midsection of the leader. The wire section may be, but is not required to be, tapered. The wire leader section includes a means for attachment 39 to the fly line 40 and tippet 41.

Leader 44 has a first section of polymeric monofilament 45, a second section of superelastic wire 46. The sections 45 and 46 are attached by any of the attachment means 39 previously described to the fly line 40 and non-metallic tippet 41. Again, additional sections of monofilament and additional sections of superelastic wire can be added. In an alternate embodiment, the section of superelastic wire can be located between two monofilament sections. In all of leaders shown in FIGS. 4, 35, 42 and 44, are to be connected to a fly line 40 and a tippet 41 when fly fishing.

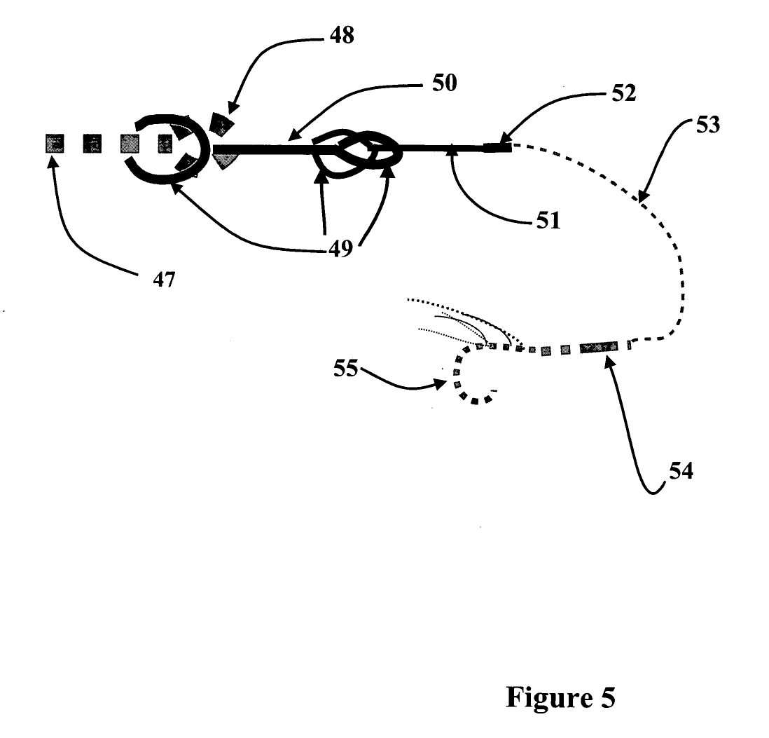

FIG. 5 illustrates a fly line 47 connected by fly line loops 48 and wire loop 49 to the leader's wire butt section 50 and wire mid-section 51, by means previously described, and joined 52 to a polymeric tippet 53. The polymeric tippet 53 is attached 52 by a variety of means previously discussed to a shock tippet 54 crafted from heavy abrasion resistant monofilament or wire. The shock tippet is then connected to the hook 55. The wire shock tippet is used only when there is a chance for a fish to bite through the tippet and therefore does not serve the goals stated for the wire butt and mid-sections and is shown only for illustrative purposes. The shock tippet is further limited to no more than 12 inches in length by the IGFA for a landed fish to claim record status. IGFA further requires a fly leader to incorporate a non-metallic class tippet no less than 15 inches in length to be incorporated into a fly leader.

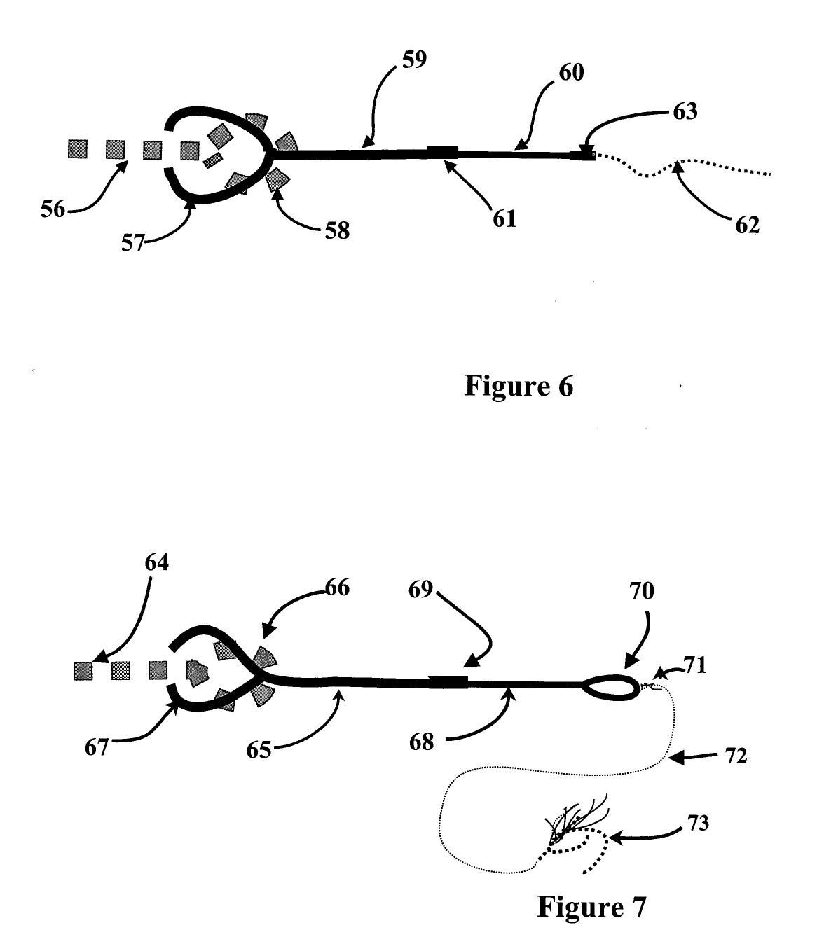

FIG. 6 illustrates another aspect of the present invention. A fly line 56 is connected to a wire section 59 via loops 57 and 58. The wire section 59 is connected to wire section 60 by a solder joint 61. A polymeric monofilament tippet 62 with attached fly 63 is tied to the wire section 60 with a knot 63. The wire sections 59 and 60 can be tapered or can be of different diameters so as to form a taper. The wire can be coated. The attachment joints can be smoothed in a number of ways, including glue or other coverings and mechanical processes. One or both of the wire sections are preferably a shape memory alloy, and most preferably, are a superelastic alloy.

FIG. 7 illustrates another aspect of the present invention. A fly line 64 is connected to a polymeric butt section 65 via loops 66 and 67. The butt section 65 is connected to a wire section 68 by a knot 69. A polymeric monofilament tippet 72 is connected via a knot 71 to the wire loop 70. A fly 73 is attached to the tippet 72.

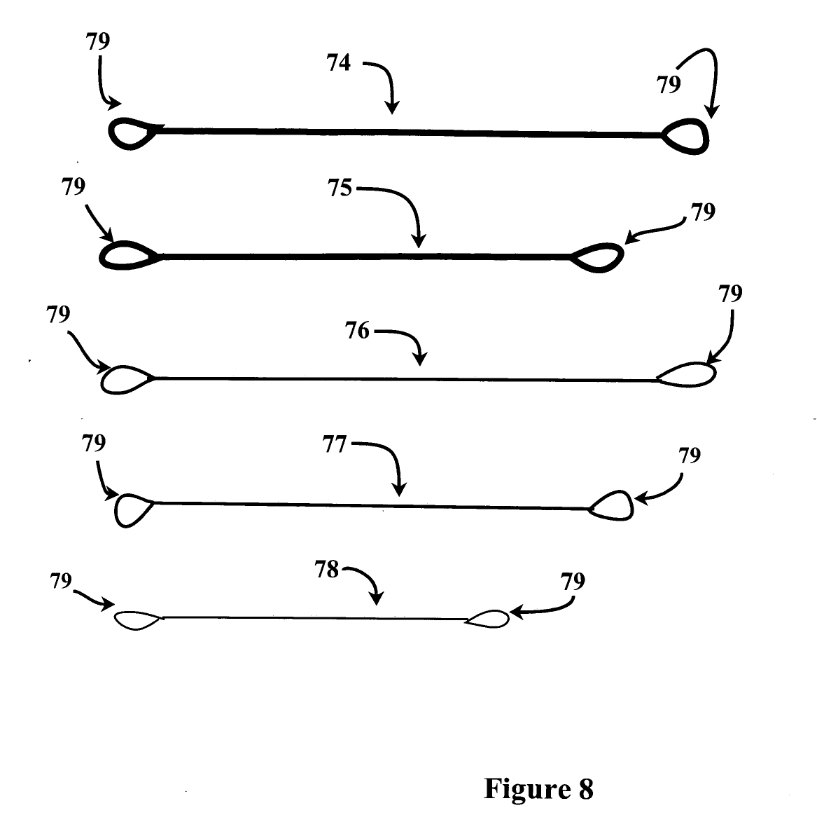

FIG. 8 illustrates wire sections that may be carried by the angler allowing for easy alteration of a leader design by adding and/or removing sections. Wires sections of varying diameters and length are shown in 74, 75, 76, 77 and 79. Each wire section terminates on both ends with a loop 79 used for attachment.

Although the present invention has been described herein with reference to particular embodiments, it is understood that these embodiments are merely illustrative of the principals and applications of the present invention. It will be apparent that various modifications and variations can be made in the apparatus and methods of the present invention without departing from the spirit and scope of the invention.

1. A leader for use in fly fishing, the leader having a midsection and a butt section, the leader, comprising:
a section of wire;
a section of polymeric monofilament; and
means for attaching the section of wire to the section of polymeric monofilament.

2. The leader for use in fly fishing as claimed in claim 1, wherein the section of wire is the butt section and the section of polymeric monofilament is the midsection.

3. The leader of claim 1, wherein the section of wire is the midsection and the section of polymeric monofilament is the butt section.

4. The leader for use in fly fishing as claimed in claim 1, wherein the leader connected is between the fly line and the tippet section.

5. The leader for use in fly fishing as claimed in claim 1, further comprising one or more additional sections of wire in the midsection or in the butt section of the leader.

6. The leader for use in fly fishing as claimed in claim 1, further comprising one or more additional sections of polymeric monofilament in the midsection or in the butt section of the leader.

7. The leader for use in fly fishing as claimed in claim 1, wherein the wire is a shaped memory alloy.

8. The leader for use in fly fishing as claimed in claim 7, wherein the wire is made from a superelastic alloy.

9. The leader for use in fly fishing as claimed in claim 1, wherein the wire is made from a Nickel-Titanium alloy.

10. The leader for use in fly fishing as claimed in claim 1, wherein the means of attachment is selected from the group consisting of loops, knots, solder joint, welds, adhesive joint, shrink tubes and crimps.

11. The leader for use in fly fishing as claimed in claim 1, wherein the section of wire is tapered.

12. The leader for use in fly fishing as claimed in claim 1, wherein the section of polymeric monofilament is tapered.

13. The leader for use in fly fishing as claimed in claim 1, further comprising means for surrounding the means for attaching.

14. The leader for use in fly fishing as claimed in claim 1 wherein the means for surrounding is mechanically ground.

15. The leader for use in fly fishing as claimed in claim 13, the means for surrounding being selected from the group consisting of adhesive, plastic or sleeves.

16. The leader for use in fly fishing as claimed in claim 1, further comprising a coating on the section of wire.

17. The leader for use in fly fishing as claimed in claim 1, further comprising a bend in the section of wire not to exceed 90 degrees.

18. The leader for use in fly fishing as claimed in claim 1, wherein the wire section is of uni-filament construction.

19. The leader for use in fly fishing as claimed in claim 1, wherein the wire section is of multifilament construction.

20. The leader for use in fly fishing as claimed in claim 19, wherein the wire section is furled, twisted, or held together by a coating.

21. A leader for use in fly fishing comprising a wire having a taper, a first attachment means on a first end of the wire and a second attachment means on second end of the superelastic wire.

22. The leader for use in fly fishing as claimed in claim 19, wherein the wire is a shaped memory alloy.

23. The leader for use in fly fishing as claimed in claim 19, wherein the wire is Nitinol.

24. The leader for use in fly fishing as claimed in claim 20, further comprising an angle in the wire.

25. The leader for use in fly fishing as claimed in claim 20, further comprising an angle in the wire not exceeding 90°.
